(19) United States
(12) Patent Application Publication
(10) Pub. No.: US 2015/0077218 A1
(43) Pub. Date: Mar. 19, 2015

(54) Virtual Gate and Alarm System

(71) Applicant: 3M INNOVATIVE PROPERTIES COMPANY, St. Paul, MN (US)

(72) Inventor: Anusorn Chakkaew, Bangkok (TH)

(21) Appl. No.: 14/387,409

(22) PCT Filed: Mar. 12, 2013
(86) PCT No.: PCT/US2013/030363

§ 371 Date: Sep. 23, 2014

Related U.S. Application Data
(60) Provisional application No. 61/619,957, filed on Apr. 4, 2012.

(51) Int. Cl. G07C 9/02

(52) U.S. Cl. CPC G07C 9/02
USPC 340/5.2

(57) ABSTRACT

Alarm systems that include testing components for determining if static control devices satisfy certain specifications are described. The alarm system includes virtual gate components that generate alarm signals if after a testing component associated with a first subinterval determines a static control device carried by a person satisfies a first specification, a person attempts to cross a second subinterval which does not overlap the first subinterval.

### BACKGROUND

In the assembly and handling of electronic devices and systems, electrostatic discharge may damage sensitive components. Uncontrolled, unexpected, or sudden electrostatic discharge may also create dangerous situations in the handling of highly combustible or flammable components. Static control devices, such as specially designed shoes and wrist straps that dissipate any accumulated charge, are available to ensure the safe handling of static-sensitive products and components. These devices, however, fail to serve their purpose if they are not worn, damaged, or otherwise inoperable. A physical door or turnstile may provide persons with selective entry to a static-controlled area, conditioned on their equipment satisfying certain operability criteria; however, such configurations may be expensive or impractical for installation and use in smaller facilities.

### SUMMARY

In one aspect, the present disclosure describes an alarm system. In some embodiments, the alarm system includes a first testing component for determining if a first static control device carried by a first person positioned at a first location but not a second location satisfies a first specification, the first testing component being associated with a first subinterval within a common passageway, and a second testing component for determining if a second static control device carried by a second person positioned at a second location but not a first location satisfies a second specification, the second testing component being associated with a second subinterval within the common passageway. The alarm system also includes a first virtual gate component communicating with the first testing component and generating a first alarm signal if after the first testing component determines and communicates to the first virtual gate component that the first static control device satisfies the first specification the first person attempts to cross the common passageway and the second subinterval. Further, the alarm system includes a second virtual gate component communicating with the second testing component and generating a second alarm signal if after the second testing component determines and communicates to the second virtual gate component that the second static control device satisfies the second specification the second person attempts to cross the common passageway and the first subinterval.

### BRIEF DESCRIPTION OF THE DRAWINGS

FIG. 1 is a schematic plan view of a system including an alarm system and a virtual gate.

FIG. 2 is a perspective view of a system using the alarm system and virtual gate of FIG. 1.

### DETAILED DESCRIPTION

Embodiments of the present disclosure include a virtual gate that may allow selective access into a particular area and an alarm system that may produce visual or audible signals when entry is attempted without first interfacing with a testing component to determine satisfaction of predetermined criteria, after failing to satisfy said criteria, or if crossing is attempted through the wrong portion of a passageway. The testing component may verify that the resistance of a static control device, such as a wrist strap or footwear, is within acceptable limits.

Because the virtual gate system requires no physical door or turnstile, installation and maintenance costs may be significantly lower. The absence of complicated moving parts which may require frequent lubrication and a supply of compressed air may be attractive for smaller facilities. Further, because there is no physical barrier to entry or exit to may become stuck, jammed, immovable, or inoperable, said virtual gate may be used as an exit in emergencies without further adaptation, even with loss of power.

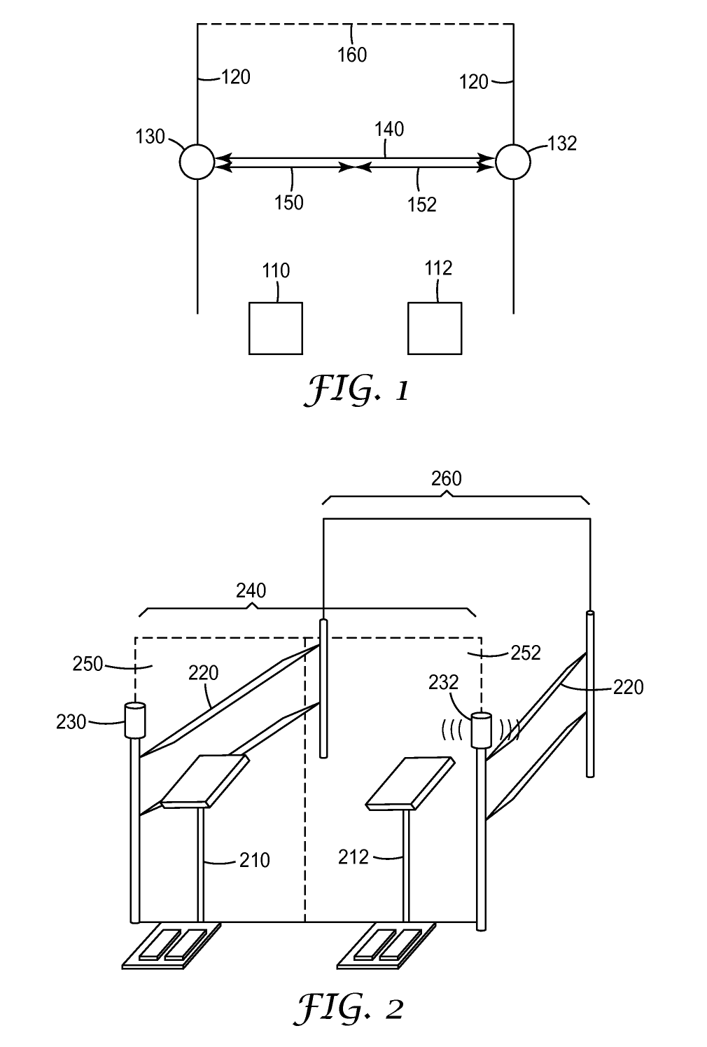

FIG. 1 depicts a schematic plan view of a system including a virtual gate and alarm system to control passage through threshold 160. The system includes a first testing component 110 and a second testing component 112. Barriers 120 prevent passage through the threshold 160 without crossing common passageway 140 and either first subinterval 150 or second subinterval 152. The system further includes first virtual gate component 130 and second virtual gate component 132.

First testing component 110 and second testing component 112 may be any suitable device for detecting or measuring any desired control characteristic. The testing components may determine the operability of a device, for example a static control device, by measuring its resistance. First and second testing component 110 and 112 may test the same characteristic or they may measure different characteristics. In some embodiments, each testing component may be adapted to test more than one device at the same time, for example, a static control wrist strap and static control shoes. Either or both of first testing component 110 or second testing component 112 may have suitable controls, displays, indicators and inputs that may facilitate a user's interactions with the testing components. Further, first testing component 110 may be positioned at a first location and second testing component 112 may be positioned at a second location. The locations may be sufficiently spaced such that a person may only be at one location at a time. Each of the testing components may be associated with a respective subinterval, i.e., first testing component 110 at a first location may be associated with first subinterval 150, and second testing component 112 at a second location may be associated with second subinterval 152.

Barriers 120 may be any suitable construction and made from any material. Depending on the particular application, barriers 120 may be poles, rails, fences, walls, gates, bars, ropes, painted lines, or they make take any other suitable form that may either indicate crossing barriers 120 is forbidden or physically impede or prevent one from crossing barriers 120.

In some embodiments, common passageway 140 spans the width of barriers 120. Barriers 120 may indicate the limits or dimensions of the common passageway 140. Common passageway 140 may be a beam of light that is at least partially interrupted by an object passing through. Likewise, first subinterval 150 and second subinterval 152 may also together span the width of barriers 120. The subintervals can be equal in width, i.e., they can each span 50% of the common passageway 140, or they can each cover different proportions of the common passageway. Separating structures, paths, or markings may indicate the approximate width and location of each subinterval. Though first subinterval 150 and second subinterval 152 are depicted as being slightly in front of common passageway 140 for ease of illustration, any suitable configuration may be used, including subintervals 150 and 152 and common passageway 140 being coincident.

First virtual gate component 130 and second virtual gate component 132 are located at opposite ends of common passageway 140. In some embodiments, the first and second virtual gate components are attached to each of the barriers 120. Either of the first or second virtual gate components 130 and 132 may generate the beam corresponding to common passageway 140 For example, in some embodiments, first virtual gate component 130 may include means for generating a beam, such as a laser, and second virtual gate component 132 may include means for sensing the presence or absence of said beam, or vice versa. Both first virtual gate component 130 and second virtual gate component 132 may be capable of both transmitting and sensing beams; in some embodiments, common passageway 140 may correspond with two separate beams at different heights. Further, each of the virtual gate components 130 and 132 may also include suitable means for generating an audible alarm, such as a beep, buzzer, or siren, or visual alarm, such as a flashing or rotating light, or both.

Additionally, one or both of first virtual gate component 130 and second virtual gate component 132 may be configured with a suitable sensor, e.g., a proximity sensor, in order to determine, in the event of beam interruption, the location, i.e., the subinterval, of the interruption. The sensor or sensors may be configured to detect whether any interruption at all occurred in each subinterval, or the sensor or sensors may be configured to detect which subinterval had the greatest interruption.

In one embodiment, if, after first testing component 110 determines and communicates to first virtual gate component 130 that static control equipment carried (including worn) by a person satisfies a first specification, the person attempts to cross common passageway 140 and second subinterval 152, first virtual gate component 130 will detect the unauthorized crossing and generate an alarm signal. Likewise, if, after second testing component 112 determines and communicates to second virtual gate component 132 that static control equipment carried (including worn) by a person satisfies a second specification, the person attempts to cross common passageway 140 and first subinterval 150, second virtual gate component 132 will detect the unauthorized crossing and generate an alarm signal.

In normal operation of another embodiment, a person wearing static control equipment approaches, for example, first testing component 110. At this point, if the person attempts to cross common passageway 140 and first subinterval 150, first virtual gate component 130 will detect the unauthorized crossing and generate an alarm signal. Likewise, at this point, second virtual gate component 132 will detect a person crossing common passageway 140 and second subinterval 152 and generate an alarm signal. A person may gain entry through a subinterval by interfacing with the corresponding testing component. For example, for entry through subinterval 150, a person must interface with testing component 110. Likewise, for entry through subinterval 152, a person must interface with testing component 112.

In some embodiments, the testing component may verify that the static control equipment satisfies one or more criteria. The testing component may have a port, plate, or other connectivity to incorporate the static control equipment into an electrical circuit. The testing component may then be able to detect the presence, operability, and resistance of the internal resistor via the change in voltage or current. If certain criteria are satisfied, the testing component may communicate with its corresponding virtual gate component via any suitable interface, e.g., via a physical wire, wireless, infrared beam, etc. to allow temporary entry through the corresponding subinterval. For purposes of this application, because entry is never made physically impossible with a virtual gate, entry means crossing a subinterval without triggering one or more of the virtual gate components to generate an alarm. Upon receiving the communication from the testing component, one or both of the virtual gate components may generate an audible or visual signal that indicates entry is permitted across one or both of the subintervals. The entry, i.e., the ability to cross the subinterval without triggering the virtual gate components to generate an alarm, may be of any suitable duration, for example, three or five seconds. Alternatively, the entry may last for a certain amount of time after disconnecting the static control equipment from the testing component. In some embodiments, the virtual gate components may be configured to allow only one entry through the corresponding subinterval after communication from the testing components indicating the satisfaction of the criteria. That is, the virtual gate component will not generate an alarm signal for the first time the beam across common passageway 140 is interrupted. Any suitable combination of these methods of controlling access may be utilized, for example, some embodiments may allow only one entry, provided that it occurs within a certain duration, e.g., ten seconds.

FIG. 2 is a perspective view of the system including an alarm system and virtual gate of FIG. 1. The system includes first testing component 210 and second testing component 212, barriers 220, first virtual gate component 230, second virtual gate component 232, common passageway 240, first subinterval 250, second subinterval 252, and threshold 260.

Barriers 220 are shown as fences in FIG. 2, but barriers 220 may take any suitable form which indicates the dimensions of the common passageway 240 or indicates crossing barriers 220 is forbidden. Barriers 220 may also physically impede or prevent one from crossing threshold 260 without crossing the common passageway 240.

In some embodiments, in order to pass through threshold 260 via common passageway 240 and first subinterval 250, a first person attempting entry needs to first interface with first testing component 210. If testing component 210 determines equipment carried or worn by the first person satisfies a first specification, the first person may cross the common passageway 240 and first subinterval 250 without the first virtual gate component 230 generating an alarm signal.

If instead, for example, a second person attempts to cross threshold 260 via common passageway 240 and second subinterval 252 without interfacing with second testing component 212, or after second testing component determines that equipment carried or worn by the second person does not satisfy a second specification, second virtual gate component 232 will generate an alarm signal when it detects the second person attempting to cross common passageway 240 and second subinterval 252.

In some embodiments, if, after first testing component 210 determines and communicates to first virtual gate component 230 that a person's static control equipment satisfies a first specification, the person attempts to cross common passageway 240 and second subinterval 252, first virtual gate component 230 will detect the unauthorized crossing and generate an alarm signal. Likewise, if, after second testing component 212 determines and communicates to second virtual gate component 232 that static control equipment carried (including worn) by a person satisfies a second specification, the person attempts to cross common passageway 240 and first subinterval 250, second virtual gate component 232 will detect the unauthorized crossing and generate an alarm signal.

First subinterval 250 and second subinterval 252 are shown in dashed lines to represent the approximate locations of these subintervals. While from a technical perspective the dimensions of these subintervals may in fact be different, for example, because the crossing of each subinterval may be solely determined by interrupting a narrow beam generated at the level of the first and second virtual gate components 230 and 232, the depiction of these subintervals in FIG. 2 represents the functional location of the subintervals for a human of average height walking through common passageway 240.

Following are a list of items of the present disclosure.

Item 1 is an alarm system, comprising:
a first testing component for determining if a first static control device carried by a first person who is positioned at a first location but not a second location satisfies a first specification, the first location and the first testing component being associated with a first subinterval within a common passageway;
a second testing component for determining if a second static control device carried by a second person who is positioned at the second location but not the first location satisfies a second specification, the second location and the second testing component being associated with a second subinterval within the common passageway, the second subinterval not overlapping the first subinterval;
a first virtual gate component communicating with the first testing component and generating a first alarm signal if after the first testing component determines and communicates to the first virtual gate component that the first static control device satisfies the first specification the first person attempts to cross the common passageway and the second subinterval;
a second virtual gate component communicating with the second testing component and generating a second alarm signal if after the second testing component determines and communicates to the second virtual gate component that the second static control device satisfies the second specification the second person attempts to cross the common passageway and the first subinterval.

Item 2 is the alarm system of item 1, wherein the first virtual gate component does not generate an alarm signal if after the first testing component determines and communicates to the first virtual gate component that the first static control device satisfies a first specification the first person attempts to cross the common passageway and the first subinterval.

Item 3 is the alarm system of item 1, wherein the second virtual gate component does not generate an alarm signal if after the second testing component determines and communicates to the second virtual gate component that the second static control device satisfies the second specification, the second person attempts to cross the common passageway and the second subinterval.

Item 4 is the alarm system of item 1, wherein the first testing component comprises a device for measuring the electrical resistance of the first static control device.

Item 5 is the alarm system of item 1, wherein the first virtual gate component comprises a signal transmitter for transmitting a signal across the common passageway to a signal receiver, the first virtual gate component recognizing an attempt to cross the common passageway when the signal is at least partially blocked.

Item 6 is the alarm system of item 1, wherein the first virtual gate component comprises a proximity sensor for determining whether the first person crosses the common passageway through the first subinterval or the second subinterval.

The present invention should not be considered limited to the particular examples and embodiments described above, as such embodiments are described in detail in order to facilitate explanation of various aspects of the invention. Rather, the present invention should be understood to cover all aspects of the invention, including various modifications, equivalent processes, and alternative devices falling within the scope of the invention as defined by the appended claims and their equivalents.

1. An alarm system, comprising:
a first testing component for determining if a first static control device carried by a first person who is positioned at a first location but not a second location satisfies a first specification, the first location and the first testing component being associated with a first subinterval within a common passageway;
a second testing component for determining if a second static control device carried by a second person who is positioned at the second location but not the first location satisfies a second specification, the second location and the second testing component being associated with a second subinterval within the common passageway, the second subinterval not overlapping the first subinterval;
a first virtual gate component communicating with the first testing component and generating a first alarm signal if after the first testing component determines and communicates to the first virtual gate component that the first static control device satisfies the first specification the first person attempts to cross the common passageway and the second subinterval;
a second virtual gate component communicating with the second testing component and generating a second alarm signal if after the second testing component determines and communicates to the second virtual gate component that the second static control device satisfies the second specification the second person attempts to cross the common passageway and the first subinterval.

2. The alarm system of claim 1, wherein the first virtual gate component does not generate an alarm signal if after the first testing component determines and communicates to the first virtual gate component that the first static control device satisfies a first specification the first person attempts to cross the common passageway and the first subinterval.

3. The alarm system of claim 1, wherein the second virtual gate component does not generate an alarm signal if after the second testing component determines and communicates to the second virtual gate component that the second static control device satisfies the second specification, the second person attempts to cross the common passageway and the second subinterval.

4-6. (canceled)
